(19) United States
(12) Patent Application Publication
(10) Pub. No.: US 2012/0130728 A1
(43) Pub. Date: May 24, 2012

(54) SEMANTICALLY ENABLED, DATA SENSITIVE NEGOTIATION AND COLLABORATION ENGINE

(75) Inventors: ROBERT R. FRIEDLANDER, SOUTHBURY, CT (US); JAMES R. KRAEMER, SANTA FE, NM (US); EDWARD J. MACKO, RALEIGH, NC (US)

(73) Assignee: INTERNATIONAL BUSINESS MACHINES CORPORATION, ARMONK, NY (US)

(21) Appl. No.: 12/951,139

(22) Filed: Nov. 22, 2010

(51) Int. Cl. G06Q 50/00

(52) U.S. Cl. 705/2

(57) ABSTRACT

A computer implemented method, system, and/or computer program product facilitates fulfillment of a term of a contract between a healthcare provider and a healthcare authorizer. A healthcare provider profile that describes a first set of business priorities for a healthcare provider and a healthcare authorizer profile that describes a second set of business priorities for a healthcare authorizer are created. A request is received from the healthcare provider for the healthcare authorizer to fulfill a term of a contract between the healthcare provider and the healthcare authorizer. Confidential data is received from the healthcare provider and the healthcare authorizer. A solution that fulfils the request is then generated, based on the contract, the healthcare provider profile, the healthcare authorizer profile, and the confidential data.

### BACKGROUND

The present disclosure relates to the field of computers, and specifically to the use of computers in business usage. Still more particularly, the present disclosure relates to the use of computers in facilitating the fulfillment of contract terms between parties.

There are many commercial and other situations where multiple parties must agree on complex analytics based on multiple sources of complex heterogeneous data. Often the parties have differing or sometimes contradictory goals and purposes. An example might include a healthcare authorizer and a healthcare provider negotiating cohort based pay for performance. The parties wish to reach agreement, but each wishes the most favorable terms. Each may provide some of the data. The different parties each may use different terminology, different candidate metrics, etc.

### BRIEF SUMMARY

A computer implemented method, system, and/or computer program product facilitates fulfillment of a term of a contract between a healthcare provider and a healthcare authorizer. A healthcare provider profile that describes a first set of business priorities for a healthcare provider and a healthcare authorizer profile that describes a second set of business priorities for a healthcare authorizer are created. A request is received from the healthcare provider for the healthcare authorizer to fulfill a term of a contract between the healthcare provider and the healthcare authorizer. Confidential data is received from the healthcare provider and the healthcare authorizer. A solution that fulfils the request is then generated, based on the contract, the healthcare provider profile, the healthcare authorizer profile, and the confidential data.

### BRIEF DESCRIPTION OF THE SEVERAL VIEWS OF THE DRAWINGS

FIG. 1 depicts an exemplary computer in which the present disclosure may be implemented;

FIG. 2 illustrates relationships among a contract facilitating computer, a healthcare provider's computer bot, and a healthcare authorizer's computer bot; and

FIG. 3 is a high level flow chart of one or more exemplary steps taken by a processor to facilitate fulfillment of a term of a contract between a healthcare provider and a healthcare authorizer.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

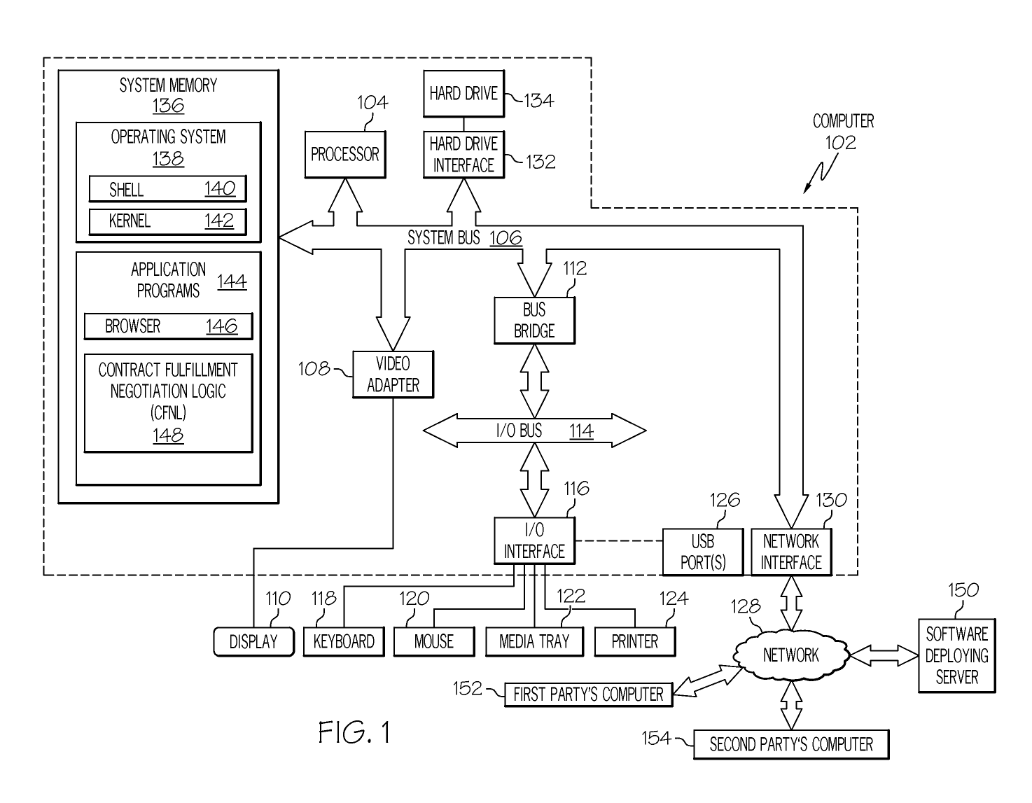

With reference now to the figures, and in particular to FIG. 1, there is depicted a block diagram of an exemplary computer 102, which may be utilized by the present invention. Note that some or all of the exemplary architecture, including both depicted hardware and software, shown for and within computer 102 may be utilized by software deploying server 150, first party's computer 152, and/or second party's computer 154.

Computer 102 includes a processor 104 that is coupled to a system bus 106. Processor 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150, a first party's computer 152 and/or a second party's computer 154 using a network interface 130 to a network 128. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

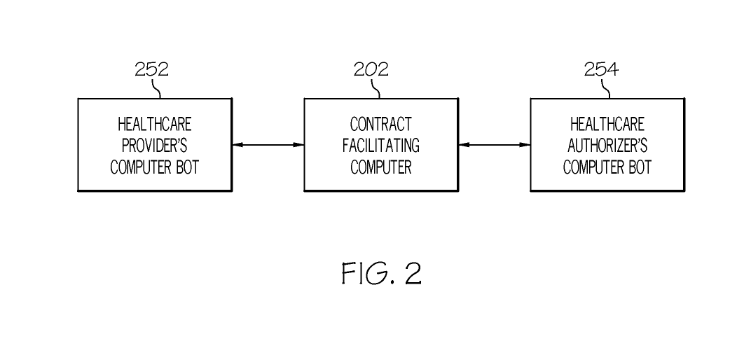

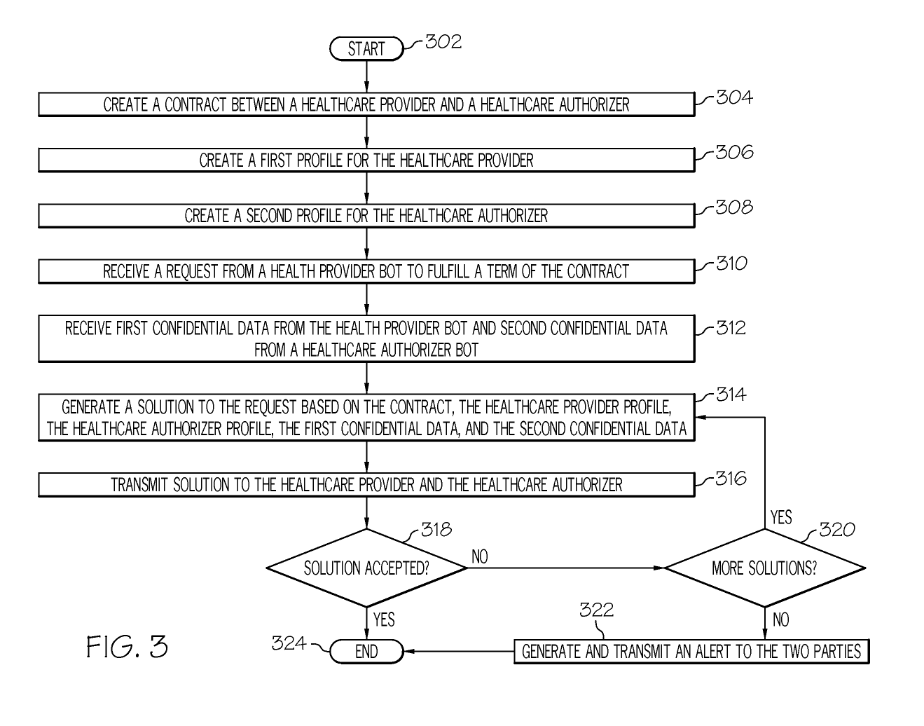

Application programs 144 in computer 102's system memory (as well as software deploying server 150's system memory) also include a contract fulfillment negotiation logic (CFNL) 148. CFNL 148 includes code for implementing the processes described below, including those described in FIGS. 2-3. In one embodiment, computer 102 is able to download CFNL 148 from software deploying server 150, including in an on-demand basis, wherein the code in CFNL 148 is not downloaded until needed for execution to define and/or implement the improved enterprise architecture described herein. Note further that, in one embodiment of the present invention, software deploying server 150 performs all of the functions associated with the present invention (including execution of CFNL 148), thus freeing computer 102 from having to use its own internal computing resources to execute CFNL 148.

The hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

Parties that are in a contractual arrangement may have different profiles, goals and desired metrics. That is, the needs/desires of one party are often different from the other party to a contract. Thus, when a request is made to fulfill a term of a contract, there may be difficulties in arriving at an equitable solution, based on these differences. Further, there may be semantic differences, in which one party refers to contractual terms using one lexicon, while the other party uses another.

There are many commercial and other situations where multiple parties must agree on complex analytics based on multiple sources of complex heterogeneous data. Often the parties have differing or sometimes contradictory goals and purposes. An example might include a healthcare authorizer and a healthcare provider negotiating cohort-based pay (e.g., pay to members of a group per terms of a particular contract) for performance. The parties wish to reach an agreement regarding payment, but each wishes the most favorable terms. Furthermore, each party may provide some of the data using different terminology, different candidate metrics, etc.

For example, consider a situation in which a doctor is seeing a patient in his office. The patient shows symptoms that suggest that certain tests should be run, and/or a specialist called in. The doctor (healthcare provider) and the insurance company (healthcare authorizer) have a contract that loosely describes when tests/referrals can be performed, and the fee schedule for the doctor. The contract is “loose” since it gives both parties wiggle room. For example, the contract may have a range of fees in a fee schedule, which are flexible. Furthermore, the insurance company may have the option to decide whether or not a test is “essential”, based on costs, the disease group, co-morbidity, etc. That is, the insurance company may have the option to deny a test if getting the disease will only result in minimal results if the patient goes untreated, while approving the test if denying the test will result in catastrophic illness. Similarly, the doctor may have the option to “code red” a patient, “code red” indicating that treatment is mandatory and not optional, in accordance with the patient's condition. The use of a “code red” may be subject to a prohibition against flagging all patients as “code red” just to get them routinely approved. Thus, the doctor and the insurance company may have conflicting concerns. In order to bring them to an agreement, a contract facilitating computer will look at confidential data from each party. That is, the doctor may have confidential data/issues (e.g., his current cash-flow, confidential information about the patient, confidential data regarding efficacy of certain types of treatment, etc.) that he can't share with the insurance company. Similarly, the insurance company may have confidential data/issues (e.g., a statutory deadline to pay out a claim, cash flow issues, pending litigation regarding denial of treatment for similar conditions, etc.) that it can't share with the doctor. However, a confidential computer system (contract facilitating computer) can receive this confidential data from the software robots (bots) from the doctor's computer and the insurance company's computer in order to negotiate a solution to how terms of the contract can be performed such that both parties are satisfied.

Referring now to FIG. 2, relationships among a contract facilitating computer (e.g., computer 102 shown in FIG. 1), a healthcare provider's computer bot 252 (e.g., a software bot that monitors activity on, and provides communication functionality for, a healthcare provider's computer such as first party's computer 152 shown in FIG. 1), and a healthcare authorizer's computer bot 254 (e.g., a software bot that monitors activity on, and provides communication functionality for, a healthcare authorizer's computer such as second party's computer 154 shown in FIG. 1). Note that the healthcare provider may be any type of healthcare provider, such as physicians, hospitals, clinics, etc., that provides medical treatment to patients. The healthcare authorizer may be any entity/party that authorizes the medical treatment and/or payment for such treatment. Examples of healthcare authorizers include, but are not limited to, insurance carriers/adjusters, third party healthcare policy administrators, ethics boards in a hospital, etc.

With reference now to FIG. 3, a high level flow chart of steps taken to facilitate fulfillment of a term of a contract between a healthcare provider and a healthcare authorizer is presented. After initiator block 302, a contract is created between a healthcare provider (e.g., a doctor) and a healthcare authorizer (e.g., an insurance company, a third party administrator that authorizes allocation of treatment options to a group, etc.), as described in block 304.

As described in blocks 306 and 308, profiles are created for the healthcare provider and the healthcare authorizer. The healthcare provider profile describes a set of business priorities for the healthcare provider. Examples of such business priorities for the healthcare provider include financial priorities (e.g., what level of fees are required to meet the business plan of the healthcare provider), patient health priorities (e.g., what treatment is deemed necessary to provide each particular patient with the appropriate type and/or level of healthcare), legal priorities (e.g., what treatment is deemed required in order to avoid malpractice), etc. Difficult decisions must be made to harmonize such priorities.

Similarly, the healthcare authorizer profile describes a set of business priorities for the healthcare authorizer. Examples of such business priorities for the healthcare provider include maintenance of cash levels required by standard practices and/or statute, ensuring customer satisfaction from both the healthcare provider and the patient, complying with timeliness of payments, etc.

Each party's profile can be derived in several ways. In one embodiment, a party's profile is simply created by a specific party responding to a questionnaire. For example, the healthcare authorizer may answer to the questionnaire that all requests for treatment authorization from a healthcare provider must be responded to within 15 minutes, one hour, or one day, depending on the type of treatment (urgent, acute, on-going) being proposed. Similarly, the healthcare provider may answer to the questionnaire that payment for treatment needs to be paid within 30 days. In another embodiment, however, such questions may be the subject of industry standards and/or statutes, which can automatically provide such criteria to the profiles.

As depicted in block 310, the contract facilitating computer 202, shown in FIG. 2, may receive a request from a healthcare provider. This request is a request that authorization and/or payment approval be provided by a healthcare authorizer for a particular treatment for a specific patient. In one embodiment, the request is automatically sent by a computer bot from the healthcare provider. For example, the computer bot (monitoring software) may monitor entries made by the healthcare provider into a patient's electronic chart (electronic medical record—EMR). The computer bot can recognize certain key words, associate them with the patient's history, and “know” that authorization is needed for a particular course of treatment, which may be urgent, acute, or long-term.

As described in block 312, the contract facilitating computer has received confidential data from both the healthcare provider and the healthcare authorizer. The confidential data from the healthcare authorizer is hidden from the healthcare provider, and vice versa, and may be provided by bots from the respective computers of the healthcare authorizer and healthcare provider. For example, the confidential data from the healthcare authorizer may include a rule/statement that treatment is to be more freely authorized or more tightly controlled due to recent business conditions, financial conditions, etc. The confidential data from the healthcare provider may include business information about the healthcare provider's business (e.g., financial conditions, etc.) as well as the patient for whom treatment authorization is being sought (e.g., the patient's medical condition, family/patient wishes to extend/withhold treatment, etc.).

The contract facilitating computer then generates a solution to the request (block 314). This solutions is based on the terms of the contract between the healthcare provider and the healthcare authorizer (e.g., timeliness, fee schedules, etc. that are defined in the contract); the healthcare provider profile (e.g., the business priorities that have been established by/for the healthcare provider); the healthcare authorizer profile (e.g., the business priorities that have been established by/for the healthcare authorizer); and the confidential data received from the healthcare provider and the healthcare authorizer.

As depicted in block 316, this solution is transmitted to both the healthcare provider and the healthcare authorizer. If the solution is acceptable to both parties (and/or their respective bots), as queried in query block 318, then the process ends (terminator block 324). However, if the solution is unacceptable to one or both of the parties, then the contract facilitating computer will determine if there are other solutions available (e.g., alternative treatments that can be authorized, additional fees that can be paid, etc.), as describe in query block 320. If so, then another solution is generated and presented to the two parties for their consideration (block 314). If there are no other solutions available, then an alert is sent to both parties (block 322).

Note that the healthcare authorizer profile and the healthcare provider profile can both be dynamically adjusted in response to changes to the respective current financial states of these parties. That is, if the healthcare provider is suffering from low cash flow at a particular time but the healthcare authorizer has a high reserve of cash on hand, then the contract facilitating computer may authorize a higher-than-normal fee payment, assuming that it is still within a range of fees in a contract between the healthcare care provider and the healthcare authorizer.

In one embodiment, the contract with the healthcare authorizer may be with multiple healthcare providers. Due to economies of scale, if the number of healthcare providers that are parties to the contract changes (goes up or down), the healthcare authorizer profile can be dynamically adjusted to create a new healthcare authorizer profile, in which payment of higher or lower fees is acceptable to the healthcare authorizer. Similarly, the healthcare provider's profile may dynamically change, due to current cash flow issues. Thus, in a further embodiment, if the solution generated by the contract facilitating computer, which was based on the original healthcare provider's profile and the original healthcare authorizer's profile, is deemed unacceptable to the healthcare authorizer and/or healthcare provider, then a new solution is generated based on the new healthcare provider profile and the new healthcare authorizer profile, as well as the original contract and first and second sets of confidential data.

Note that, in accordance with one embodiment of the present disclosure, requests to fulfill a term of a contract are received in a conversational manner through mechanisms of the parties' choice. Examples might include spoken language, textual narratives, graphical interfaces, etc. The requests may be in the users' human language of choice. The requests are semantically digested and iteratively matched to potential data. In one embodiment, there is a conversational feedback step where the computer “explains” the algorithms, queries, etc. it has generated to fulfill a users request back to the user and makes necessary adjustments based on user input. Once a specific user is satisfied with his specific requests, it is merged against other users' requests. The computer determines potential common solutions and areas. The computer then conversationally lays out potential solutions to the multiple users. The computer may use different strategies to try to reach a shared solution. The computer “learns” which methods work with which users groups to reach a shared solution. The computer may invoke human aid on areas that are not mechanically susceptible to shared solution. Areas for solution include metrics, data sources, processing dynamics, etc. Thus, the system is capable of building and updating (with learning) complex party profiles.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the invention of the present application in detail and by reference to illustrative embodiments thereof, it will be apparent that modifications and variations are possible without departing from the scope of the invention defined in the appended claims.

What is claimed is:

1. A method of facilitating fulfillment of a term of a contract between a healthcare provider and a healthcare authorizer, the method comprising:
a computer receiving a request from the healthcare provider for the healthcare authorizer to fulfill a term of a contract between the healthcare provider and the healthcare authorizer;
the computer receiving, from the healthcare provider, first confidential data related to the request;
the computer receiving, from the healthcare authorizer, second confidential data related to the request; and
the computer generating a solution that fulfills the request, wherein the solution is based on the contract, a healthcare provider profile, a healthcare authorizer profile, the first confidential data, and the second confidential data, wherein the healthcare provider profile describes a first set of business priorities for a healthcare provider, and wherein the healthcare authorizer profile describes a second set of business priorities for a healthcare authorizer.

2. The method of claim 1, further comprising:
the computer hiding the first confidential data from the healthcare authorizer; and
the computer hiding the second confidential data from the healthcare provider.

3. The method of claim 1, wherein the first confidential data is provided by a healthcare provider bot on a healthcare provider computer used by the healthcare provider.

4. The method of claim 3, wherein the second confidential data is provided by a healthcare authorizer bot on a healthcare authorizer computer used by the healthcare authorizer.

5. The method of claim 1, further comprising:
the computer dynamically adjusting the healthcare authorizer profile according to a current financial state of the healthcare authorizer.

6. The method of claim 1, further comprising:
in response to a change to a current financial state of the healthcare provider, the computer dynamically adjusting the healthcare provider profile to create a new healthcare provider profile.

7. The method of claim 6, further comprising:
in response to a change in a number of healthcare providers that are parties to the contract, the computer dynamically adjusting the healthcare authorizer profile to create a new healthcare authorizer profile.

8. The method of claim 7, further comprising:
the computer transmitting the solution to the healthcare provider and the healthcare authorizer; and
the computer, in response to neither the healthcare provider nor the healthcare authorizer accepting the solution, generating and transmitting a new solution to the healthcare provider and the healthcare authorizer, wherein the new solution is based on the contract, the new healthcare provider profile, the new healthcare authorizer profile, the first confidential data, and the second confidential data.

9. The method of claim 1, wherein the request is for treatment for a particular patient, wherein the first confidential data describes a condition of the particular patient, and wherein the solution comprises authorization for the treatment for the particular patient.

10. The method of claim 1, further comprising:
the computer transmitting the solution to the healthcare provider and the healthcare authorizer; and
the computer, in response to neither the healthcare provider nor the healthcare authorizer accepting the solution, generating and transmitting an alert to the healthcare provider and the healthcare authorizer.

11. A computer program product for facilitating fulfillment of a term of a contract between a healthcare provider and a healthcare authorizer, the computer program product comprising:
a computer readable storage media;
first program instructions to create a healthcare provider profile that describes a first set of business priorities for a healthcare provider;
second program instructions to create a healthcare authorizer profile that describes a second set of business priorities for a healthcare authorizer;
third program instructions to receive a request from the healthcare provider for the healthcare authorizer to fulfill a term of a contract between the healthcare provider and the healthcare authorizer;
fourth program instructions to receive, from the healthcare provider, first confidential data related to the request;
fifth program instructions to receive, from the healthcare authorizer, second confidential data related to the request; and
sixth program instructions to generate a solution that fulfils the request, wherein the solution is based on the contract, the healthcare provider profile, the healthcare authorizer profile, the first confidential data, and the second confidential data; and wherein
the first, second, third, fourth, fifth, and sixth program instructions are stored on the computer readable storage media.

12. The computer program product of claim 11, wherein the first confidential data is provided by a healthcare provider bot on a healthcare provider computer used by the healthcare provider.

13. The computer program product of claim 11, further comprising:
seventh program instructions to, in response to a change to a current financial state of the healthcare provider, dynamically adjust the healthcare provider profile to create a new healthcare provider profile; and wherein
the seventh program instructions are stored on the computer readable storage media.

14. The computer program product of claim 13, further comprising:
eighth program instructions, to in response to a change in a number of healthcare providers that are parties to the contract, dynamically adjust the healthcare authorizer profile to create a new healthcare authorizer profile; and wherein
the eighth program instructions are stored on the computer readable storage media.

15. The computer program product of claim 14, further comprising:
ninth program instructions to transmit the solution to the healthcare provider and the healthcare authorizer; and
tenth program instructions to, in response to neither the healthcare provider nor the healthcare authorizer accepting the solution, generate and transmit a new solution to the healthcare provider and the healthcare authorizer, wherein the new solution is based on the contract, the new healthcare provider profile, the new healthcare authorizer profile, the first confidential data, and the second confidential data; and wherein
the ninth and tenth program instructions are stored on the computer readable storage media.

16. A computer system comprising:
a central processing unit (CPU), a computer readable memory, and a computer readable storage device;
first program instructions to create a healthcare provider profile that describes a first set of business priorities for a healthcare provider;
second program instructions to create a healthcare authorizer profile that describes a second set of business priorities for a healthcare authorizer;
third program instructions to receive a request from the healthcare provider for the healthcare authorizer to fulfill a term of a contract between the healthcare provider and the healthcare authorizer;
fourth program instructions to receive, from the healthcare provider, first confidential data related to the request;
fifth program instructions to receive, from the healthcare authorizer, second confidential data related to the request; and
sixth program instructions to generate a solution that fulfils the request, wherein the solution is based on the contract, the healthcare provider profile, the healthcare authorizer profile, the first confidential data, and the second confidential data; and wherein
the first, second, third, fourth, fifth, and sixth program instructions are stored on the computer readable storage device for execution by the CPU via the computer readable memory.

17. The computer system of claim 16, wherein the first confidential data is provided by a healthcare provider bot on a healthcare provider computer used by the healthcare provider.

18. The computer system of claim 16, further comprising:
seventh program instructions to, in response to a change to a current financial state of the healthcare provider, dynamically adjust the healthcare provider profile to create a new healthcare provider profile; and wherein
the seventh program instructions are stored on the computer readable storage device for execution by the CPU via the computer readable memory.

19. The computer system of claim 16, further comprising:
eighth program instructions, to in response to a change in a number of healthcare providers that are parties to the contract, dynamically adjust the healthcare authorizer profile to create a new healthcare authorizer profile; and wherein
the eighth program instructions are stored on the computer readable storage device for execution by the CPU via the computer readable memory.

20. The computer system of claim 16, further comprising:
ninth program instructions to transmit the solution to the healthcare provider and the healthcare authorizer; and
tenth program instructions to, in response to neither the healthcare provider nor the healthcare authorizer accepting the solution, generate and transmit a new solution to the healthcare provider and the healthcare authorizer, wherein the new solution is based on the contract, the new healthcare provider profile, the new healthcare authorizer profile, the first confidential data, and the second confidential data; and wherein
the ninth and tenth program instructions are stored on the computer readable storage device for execution by the CPU via the computer readable memory.
